(19) United States
(12) Patent Application Publication
(10) Pub. No.: US 2021/0383945 A1
(43) Pub. Date: Dec. 9, 2021

(54) FILM MADE OF METAL OR A METAL ALLOY

(71) Applicant: Neutrino Deutschland GmbH, Berlin (DE)

(72) Inventor: Holger Thorsten Schubart, Berlin (DE)

(21) Appl. No.: 17/295,523

(22) PCT Filed: Sep. 17, 2019
(86) PCT No.: PCT/DE2019/000253

§ 371 Date: May 20, 2021

(30) Foreign Application Priority Data
Nov. 21, 2018 (DE) 10 2018 009 125.3

(51) Int. Cl. H01B 5/00; B32B 5/02; B32B 15/02; B32B 15/20; H01B 1/02

(52) U.S. Cl. CPC H01B 5/00; B32B 5/028; B32B 15/02; B32B 15/20; F21Y 2115/10; B32B 2255/06; B32B 2307/202; B32B 2307/206; B32B 2255/20; H01B 1/02

(57) ABSTRACT

A film of metal or a metal alloy which has a nonmetallic nano coating. At least one electrically conductive structure or at least one electrically conductive structural element with a thickness in the nanometre range is arranged over the known coating. The film interacts with elementary particles, in particular neutrinos.

The invention relates to the interaction of elementary particles, in particular neutrinos and matter in the form of metals or metal alloys, in particular of a film made of metal or a metal alloy which has a nonmetallic nano coating.

It is known that, during the interaction of neutrinos with matter, unlike with other known elementary particles, only processes of weak interaction occur. Therefore, neutrinos penetrate bodies having large dimensions and/or high density.

The penetration capability of the neutrinos depends on their energy. As the energy increases, the effective cross-section of the neutrinos increases and the average free wavelength decreases. The present invention assumes that the energy of the neutrinos is substantially a “constant” and is aimed at the penetration part, the molecules of metallic and/or nonmetallic structures. It is known that such metallic and/or nonmetallic structures or a film made of metal or a metal alloy preferably having a nano coating made of at least graphene and silicon interact(s) with neutrinos, i.e., during which interaction the molecules thereof, under the action of elementary particles, in particular of neutrinos, start to interact with the latter, in particular start to oscillate or increase an amplitude of oscillation of the molecules of the coated film. This is the prerequisite for drawing electric energy from such metallic structures, that is to say the coated film, within the framework of converting energy.

From WO 2016/142 056 A1, a film consisting of a metallic carrier made of a metal or a metal alloy, a carrier film which has a coating made of at least graphene and silicon, wherein the coating is a nano coating, in which graphene and silicon are present as nanoparticles, wherein the coating has 10% to 80% silicon or 20% to 90% graphene and the lattice structure of the nano coating is compacted in such a manner that this results in collisions of the molecules of the nano coating with those of the penetrating neutrinos of the nonvisible spectrum of the solar or space energy molecules, wherein the kinetic energy can be tapped as direct current via the graphene as the positive pole and the metallic carrier as the negative pole, is already known.

The object of the invention is to increase the efficiency of such a film, that is to say of the known coated film consisting of a carrier made of metal or a metal alloy. This object is achieved with the features of a film according to claim 1. Further configurations of this solution according to the invention, that is to say advantageous configurations of the film, its arrangement and its use are the subject-matter of the further claims.

Accordingly, a film consisting of a carrier made of metal or a metal alloy has a coating, wherein at least one electrically conductive structure or at least one electrically conductive structural element with a thickness in the nanometer range (nanoscale) is arranged over the known coating which contains at least graphene and silicon. This serves to afford an increase in an interaction between neutrinos and the coated film.

The thickness of the at least one electrically conductive structure or of the at least one conductive structural element is preferably 50 to 750 nanometers.

The at least one electrically conductive structure or the at least one conductive structural element can be configured, in thread or fabric form, as multiple threads arranged on the film and/or as a fabric arranged on the film. As a rule, they are configured to be three-dimensional.

If the at least one electrically conductive structure or the at least one conductive structural element is configured as a fabric arranged on the film, the fabric can be configured in the form of a mesh. This then corresponds to a lattice arranged over the film and the coating.

Structures in the form of a mesh should have a rhombus structure preferably having rhombuses with equal legs preferably with a leg length between 0.5 and 1.5 millimeters.

The at least one electrically conductive structure or the at least one conductive structural element is applied to the film by means of known methods, preferably vapor deposited or sprayed onto the film and, consequently, onto the coating thereof, wherein it is advantageous if the previous coating is cured so that the structures are demarcated from one another. The vapor depositing can also be effected by means of a template, wherein the template predefines the mesh or lattice structure of the fabric.

The at least one electrically conductive structure or the at least one conductive structural element can, for example, consist of gold, silver or another electrically conductive material or contain this such as, for example, also aluminum or copper.

A further advantageous configuration provides that multiple films according to the invention coated with at least one electrically conductive structure or at least one conductive structural element are arranged in layers, that is to say stacked to form a package, or at least one film is folded multiple times to form a kind of package in such a manner that portions of the film formed by the folding are arranged in layers or at least one film is rolled up, wherein the at least one film is enveloped in an airtight manner or is arranged in an airtight manner in a housing. The aim is to minimize a reaction with the atmosphere of the earth. The fact that a technical vacuum is present in an internal space of the housing which encloses the at least one film also comes into consideration.

Within the framework of the invention, it is further opportune that the at least one film is arranged in layers and compacted to form a package, wherein a layer formation of the at least one layered film is effected as a consequence of a pressurization on at least one side of the at least one film which lies in contact with a different sublayer of the at least one film or of a further film. The aim of this is to form a package, in which individual layers of the at least one film or the films are permanently arranged lying closely in contact with another. The at least one film can be arranged in layers with up to 500 layers and more. However, it can also be provided that the at least one film sticks or the films stick to one another due to adhesion and, thus, a permanent layer formation is guaranteed.

If the at least one film is arranged in layers as described above, the respective sublayers of the at least one film can be demarcated from one another in an electrically insulated manner by means of an insulating layer. The insulating layer is preferably, but not according to the invention, an electrically non-conductive lacquer layer.

A series connection of the films is possible, without an insulating layer, if multiple films are arranged in layers, because the carrier made of metal or a metal alloy lies in each case in contact with the known coating which acts as an opposite pole.

If an insulating layer is present between the films, if multiple films are arranged in layers, a parallel connection of the films can be effected. This can be effected in such a way that multiple energy suppliers such as, for example, accumulators are connected in parallel.

The at least one film or an arrangement of at least one film or of multiple films preferably has a device for consuming electric energy in the form of DC voltage, wherein, as soon as a conductor is applied in each case to the carrier film made of metal or a metal alloy and the coating, electric energy in the form of direct current can be dissipated, in order to supply a consumer unit such as, for example, a light-emitting diode with electric energy. The respective device for consuming electric energy is adapted to the respective technical conditions. As depicted, multiple films can be connected within the framework of a parallel connection. Likewise, the films can also be connected, irrespective of their configuration, separately in series with or without an insulating layer. However, in the case of a series connection, no insulating layer is generally required between the respective films.

Due to the specific arrangement, a film made of a metal or a metal alloy is provided, which increases the efficiency of such a structure made of metal or a metal alloy.

The invention will be explained in greater detail below on the basis of an exemplary embodiment with reference to the figures. Further advantages, features and configurations of the invention are set out, wherein:

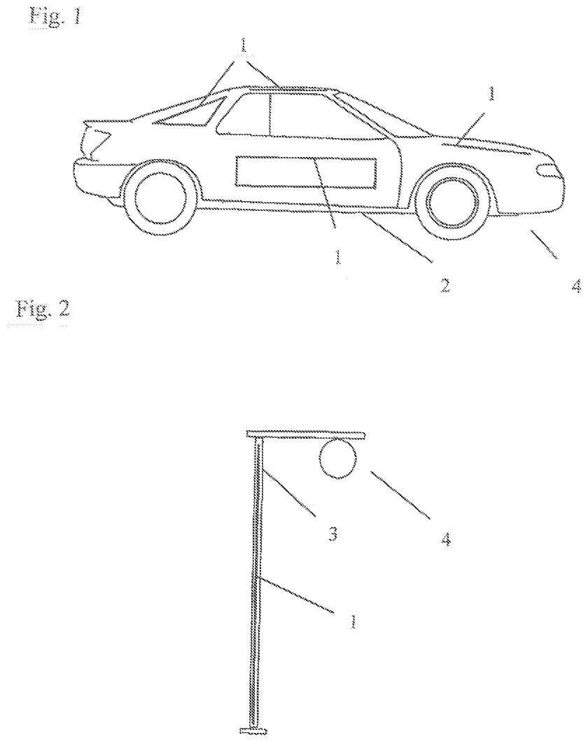

FIG. 1 shows a schematic diagram of an arrangement of films according to the invention in the form of a package as part of a body of a vehicle,

FIG. 2 shows a schematic diagram of an arrangement of films according to the invention in form of a coil in a lighting system.

According to FIG. 1 and FIG. 2, multiple films 1 according to the invention are arranged in layers in the form of a package. The films 1 themselves are, or the at least one film 1 itself is, part of a body 2, of a frame 3 according to FIG. 2 or of a housing or other suitable component of a consumer unit of electric energy, an energy consumer 4. The film 1 according to the invention can be introduced, for example within the framework of a known hybrid construction, into a frame 3 or a body 2.

The energy consumer 4 in FIG. 1 is a vehicle and is a lighting system in FIG. 2. It can, however, be any device operated with electric energy, in particular any machine operated with electric energy.

### LIST OF REFERENCE NUMERALS

1. Film
2. Body
3. Frame
4. Energy consumer

1. A film (1) consisting of a carrier made of metal or a metal alloy which has a coating, wherein at least one electrically conductive structure or at least one electrically conductive structural element with a thickness in the nanometer range is arranged over the coating and wherein the coating contains at least graphene and silicon.

2. The film (1) according to claim 1, wherein the at least one structure or the at least one structural element is configured as multiple threads arranged on the film (1) and/or as a fabric arranged on the film.

3. The film (1) according to claim 2, wherein the fabric is configured in the form of a mesh.

4. The film (1) according to claim 3, wherein structures in the form of a mesh have a rhombus structure, preferably having rhombuses with equal legs preferably with a leg length between 0.5 and 1.5 millimeters.

5. The film (1) according to claim 1, wherein the thickness of the at least one electrically conductive structure or of the at least one conductive structural element is 50 to 750 nanometers.

6. The film (1) according to claim 1, wherein the at least one electrically conductive structure or the at least one conductive structural element consists of gold, silver, aluminum or copper.

7. The film (1) according to claim 1, wherein the at least one electrically conductive structure or the at least one conductive structural element is vapor deposited or sprayed onto the film (1) and consequently onto the coating thereof.

8. The film (1) according to claim 7, wherein the vapor depositing is effected by means of a template, wherein the template predefines the mesh or lattice structure of the fabric.

9. The film (1) according to claim 1, wherein the at least one film (1) is enveloped in an airtight manner or is arranged in an airtight manner in a housing.

10. The film (1) according to claim 9, wherein a technical vacuum is present in an internal space of the housing which encloses the at least one film (1).

11. The film (1) according to claim 1, wherein the film (1) has a device for consuming electric energy.

12. An arrangement of at least one film (1) or multiple films (1) according to claim 1, wherein multiple films (1) are arranged in layers or at least one film (1) is folded multiple times in such a manner that portions of the film (1) formed by the folding are arranged in layers or at least one film (1) is rolled up.

13. The arrangement according to claim 12, wherein a layer formation of the at least one layered film (1) is effected as a consequence of a pressurization on at least one side of the at least one film (1) which lies in contact with another sublayer of the at least one film (1) or of a further film (1).

14. The arrangement according to claim 12, wherein the at least one layered film (1) or the films (1) stick(s) to one another due to adhesion during layer formation.

15. The arrangement according to claim 12, wherein respective sublayers of the at least one film (1) are demarcated from one another in an electrically insulated manner by means of an insulating layer and the insulating layer is preferably an electrically non-conductive lacquer layer.

16. The arrangement according to claim 12, wherein if multiple films (1) are arranged in layers without an insulating layer, a series connection of the films (1) can be effected, and if an insulating layer is present between multiple films (1), a parallel connection of the films (1) can be effected.

17. The arrangement of at least one film (1) claim 12, wherein the at least one film (1) is part of a frame (3), of a body (2), of a housing or of a suitable component of an energy consumer (4).

18. The arrangement of at least one film (1) according to claim 17, wherein the energy consumer (4) is a vehicle, a lighting system or a device operated with electric energy.

19. The arrangement of at least one film (1) or multiple films (1) according to claim 12, wherein a conductor is applied in each case to the carrier film made of metal or a metal alloy and the coating, and wherein electric energy can be dissipated in order to supply a consumer unit with electric energy.

20. The film according to claim 19, wherein the consumer unit is a light emitting diode.
